(19) United States
(12) Patent Application Publication
(10) Pub. No.: US 2015/0259981 A1
(43) Pub. Date: Sep. 17, 2015

(54) Ladder Guard

(71) Applicant: Zdzislaw Bobek, Calgary (CA)

(72) Inventor: Zdzislaw Bobek, Calgary (CA)

(21) Appl. No.: 13/999,624

(22) Filed: Mar. 14, 2014

(51) Int. Cl. E06C 7/18; E06C 1/14

(52) U.S. Cl. CPC E06C 7/188; E06C 1/14

(57) ABSTRACT

The Ladder Guard (1) is the first extension ladder stabilizer with multiple purposes. The product can be attached to any extension ladder and focuses on safety while climbing up and down the extension ladder. It also provides confidence to the user. The ladder does not need to be held by another person as it has the versatility of turning and can be adjusted to a variety of positions from 23° vertical to 135° horizontal to provide support (FIG. 2). The horizontal arm (6) can extend from two to three feet and has a rubber shoe (8) at the end. The Ladder Guard can be transferred from ladder to ladder with no special adjustments needed. This product insures safety making it able to use ladders on non-level ground and other difficult situations such as rooftops, hills, steps and any sloped areas etc. It includes a locking device (5) that secures the horizontal arm on the desired level locking it in place.

### FIELD OF INVENTION

This present invention relates in general to ladder support assemblies and in particular to assemblies attached to the sides of extension ladders to provide lateral support and security.

### BACKGROUND OF INVENTION

The idea of inventing the Ladder Guard came to me after a fall from an extension ladder, the side rail of the ladder bent while I was using it. I then began designing better alternatives for increasing safety on extension ladders. The Ladder Guard is designed specifically for difficult situations and obstacles at home as well as on the job site such as uneven surfaces, soft ground, hills, steps, rooftops etc. Almost on every project involving ladders you may encounter difficulties with leveling on soft or uneven ground as it makes it very unsafe to be on a ladder. The Ladder Guard's horizontal arm extends three feet and secures the ladder from sliding sideways as it provides good leverage.

The Ladder Guard allows people to climb an extension ladder in a safe, stable and confident way. The Ladder Guard that I have designed is absolutely different from the concepts described in the U.S. Pat. No. 4,802,471, No. 5,335,754, No. 4,606,432, No. 4,607,726, No. WO02/059446 A1 and No. 7,163,084 B1.

Their functions and construction is different as to use the Ladder Guard does not require any drillings or modifications to the ladders. The way it attaches to the ladder is easier. The way the horizontal arm locks in the desired angle and provides good leverage is uncomplicated to achieve. The Ladder Guard is constructed with only few parts and is easy to produce. The locking device is unique and simple to operate.

The Ladder Guard is different from the patented designs mentioned above in many ways. The way it attaches to the ladder is unique. Unlike the patents above it does not need any screws or any modifications and the way it attaches to the ladder is very secure. It is different in construction because it has a vertical metal bar which is attached to two pipes that slide into the two bottom step openings in the ladder. The vertical bar is also attached to two metal plates with angled cut grooves that are working as a locking system with a lock on it.

None of the above patents have this type of locking mechanism. The locking mechanism is unique and is attached to the horizontal moving arm. It can be locked either manually or automatically. The locking mechanism blocks the horizontal arm from moving and blocks it on the desired level. It is equipped with a spring that gives protection.

Although the patents mentioned above have the same purpose as the Ladder Guard which is to bring stability to the ladder, each one is differently designed and constructed. In contrast to the other patents the Ladder Guard can be switched easily from ladder to ladder.

Here are some points that are different in construction:

1. Attachment of the Ladder Guard: The Ladder Guard is attached to the extension ladder using two pipes which are welded to a vertical bar that fits into the two bottom openings on the ladder rail.

2. Locking mechanism: The locking mechanism is unique as it consists of two metal plates with calculated angled grooved cuts welded to the vertical bar. It is built with five different elements and is attached by screw to a horizontal arm that locks into the desired angle. The mechanism locks automatically or can be locked by hand.

The United States currently has the highest mortality rate worldwide from people falling off a ladder. It is an object of the present invention to provide a ladder attachment assembly which will provide lateral support and stability and therefore avoid accidents.

### SUMMARY OF THE INVENTION

The Ladder Guard is an adjustable ladder stabilizer which can be easily attached to any extension ladder allowing the user to work safely on the extension ladder on a variety of slippery or uneven surfaces including floors, patios, ground, pavement, etc. The Ladder Guard is relatively easy to produce, easy to install, easy to use, and above all, safe.

### BRIEF DESCRIPTION OF THE DRAWINGS

In order that the invention may be readily understood and to show more clearly how it may be implemented, reference will now be made by way of example to the accompanying drawings wherein reference numerals refer to parts and wherein:

FIG. 1: is a front view of the Ladder Guard

FIG. 2: is a front view of the Ladder Guard showing how it can be adjusted in different angles

FIG. 3: is a sectional view of the lock and the grooved plates

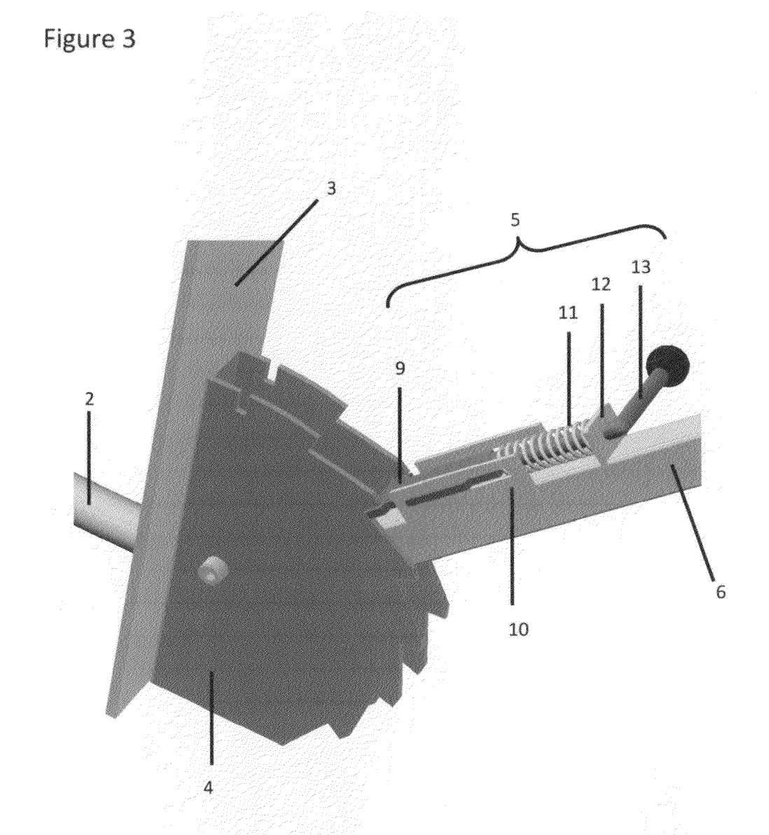

FIG. 4: is a side and a top view of the grooved plate

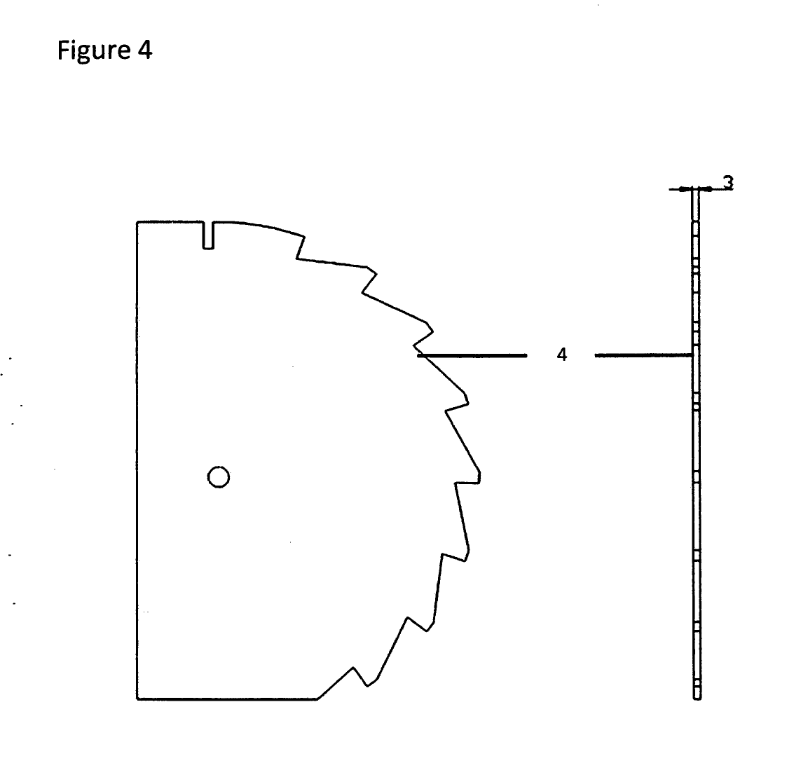

FIG. 5: is a side and a top view of parts of the lock

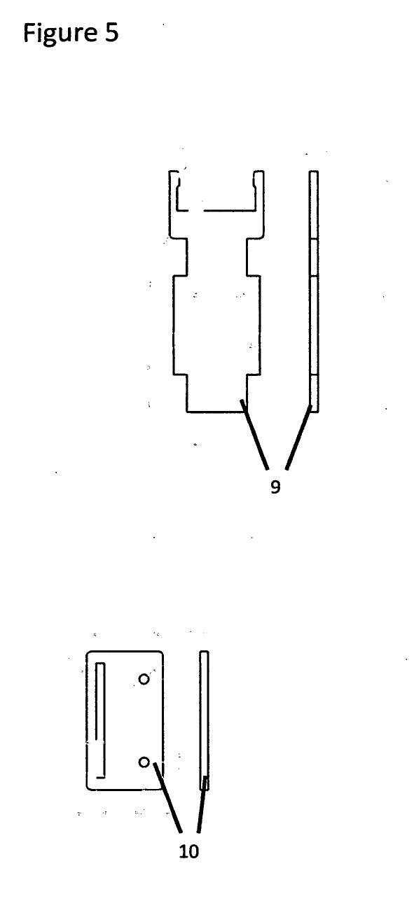

FIG. 6: is a side and a top view of parts of the lock

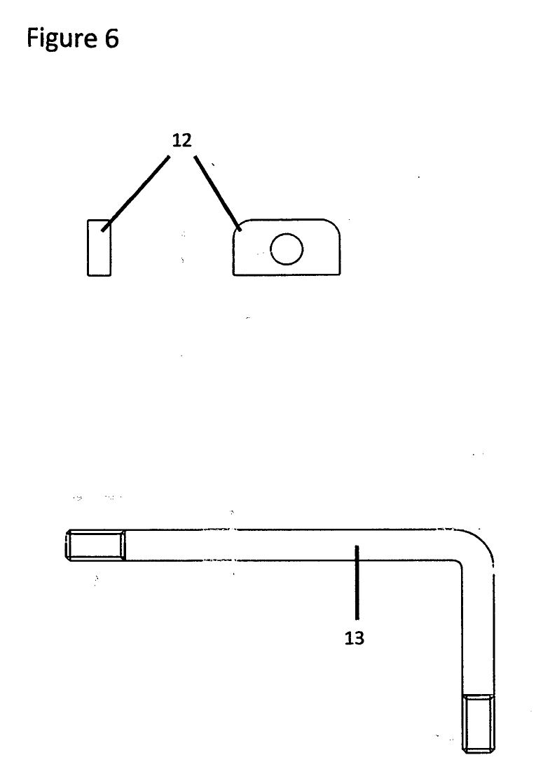

FIG. 7: are different views of the vertical bar

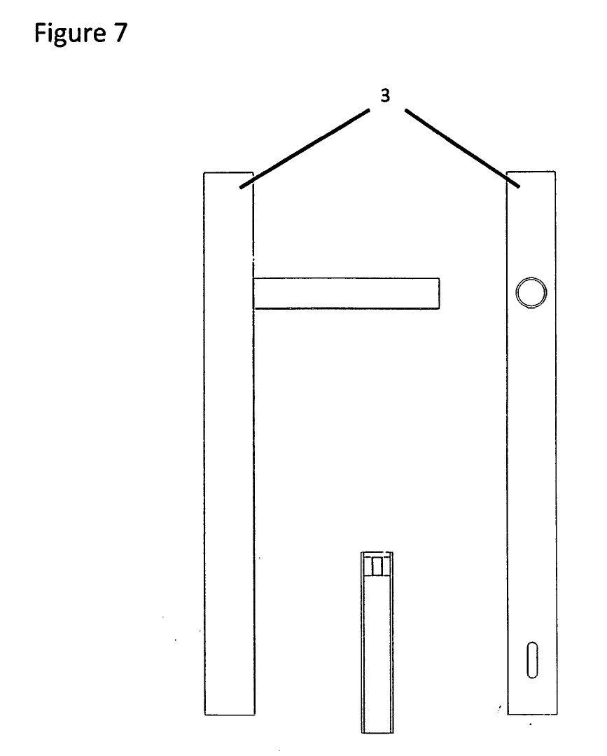

FIG. 8: are different views of the extendable arm

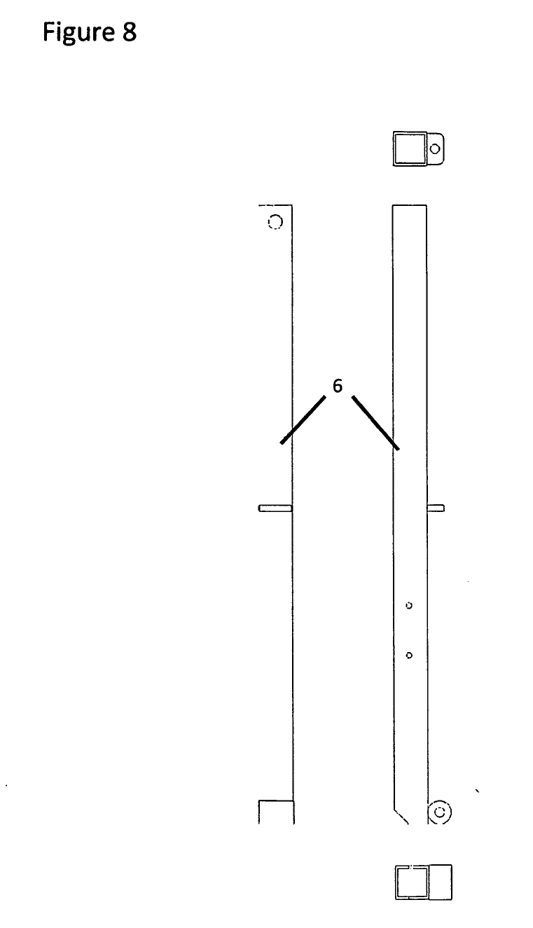

FIG. 9: are different views of the rubber foot at the end of the extendable arm

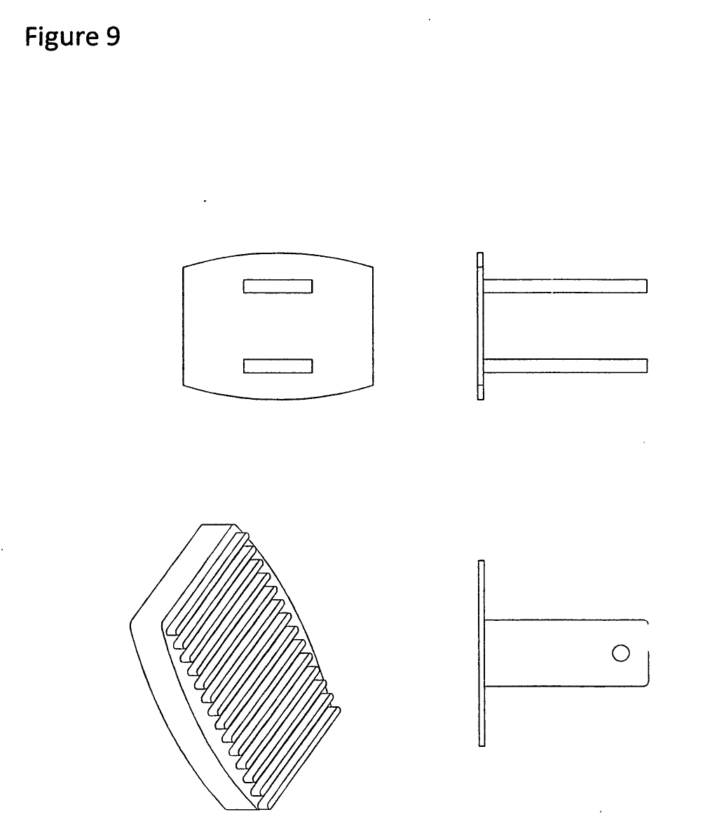

### DETAILED DESCRIPTION OF THE INVENTION

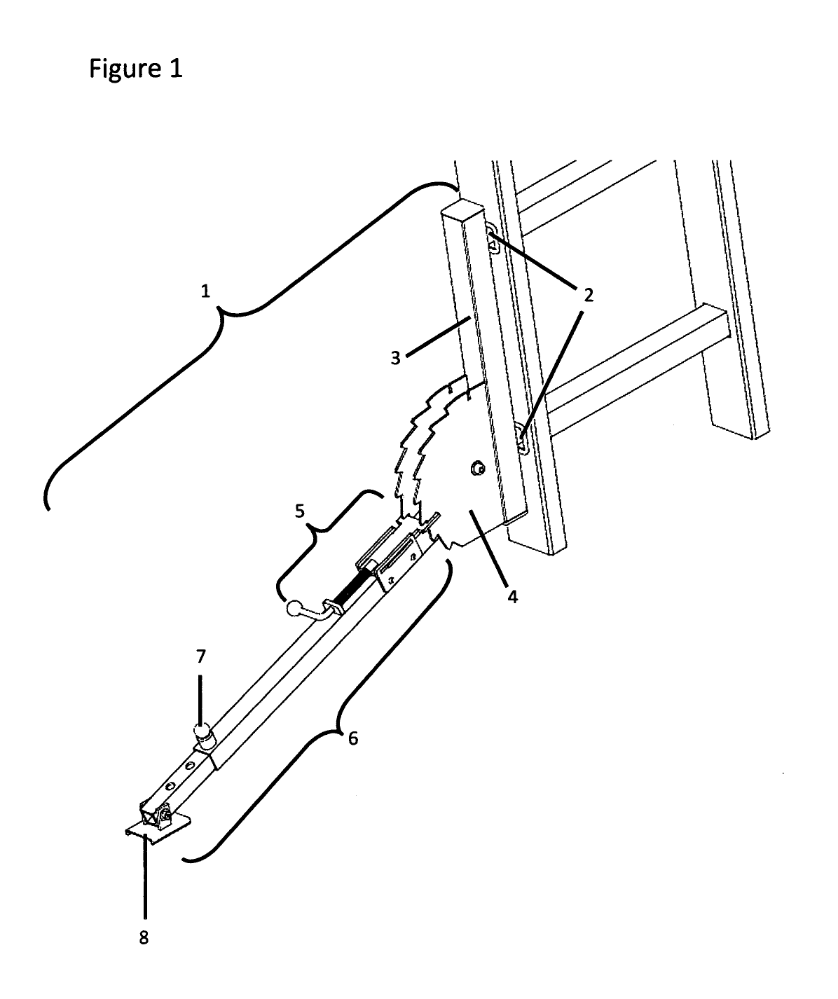

Referring to FIG. 1 which best shows the general features of the invention (1). The vertical bar (3) joins together all the parts that make the ladder stable. The pipes (2) which are joined with the vertical bar by screws (not shown) fit to the bottom openings of extension ladders. The top of the vertical bar with the pipe is adjustable vertically so it can fit to every ladder. The extendable arm (6) can be moved along two grooved plates (4) with calculated angles which are welded to the vertical bar. It can be secured with a lock (5) and a pin (7). At the end of the extendable arm there is a shoe covered with rubber (8) to pretend it from slipping.

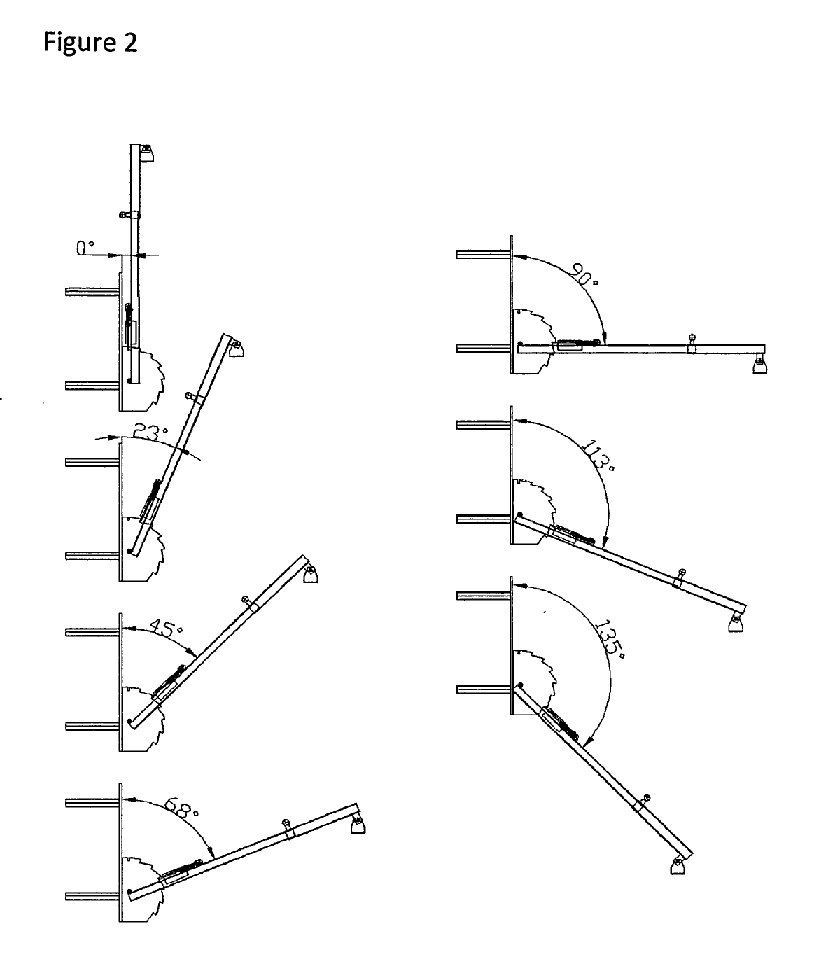

The locking mechanism (5) has a spring (11) that locks the extendable arm (6) at the levels shown in FIG. 2. The horizontal arm is made of two parts which are joined by a hinge in the center between the two plates (4) and secured by a pin (7). This mechanism makes it possible to move the extendable arm up and down.

1. The Ladder Guard is an attachment to extension ladders that prevents the ladder from falling or becoming unstable. This innovation is designed to be used on slopes, hills, soft soil, rooftops and anywhere the ladder can become unstable and become a hazard.
It takes two units on both sides of the ladder to secure it properly, one unit can be used depending on the angle and landscape of where it is being used. The product can be switched from sadder to ladder and fits all extension ladders that are used in North America.
The Ladder Guard is made of stainless steal and aluminum metals, it is designed to hold up to 250 lbs.
Its two 1″ diameter pipes slide into the 2 lowest step openings, one pipe is welded to a vertical bar and the other pipe is attached to the bolt so it can be adjusted to the steps openings.
It has two plates with grooves to lock the device into the desired level or angle, the horizontal arm can be extended and shortened as it is secured by the blocking bolt. At the end of the extended arm is a foot covered with rubber cushioning. On the horizontal arm is an attached bolt with spring and it blocks the arm on the desired level, locking it in place.
Using the Ladder Guard makes climbing on the ladder safe and provides confidence to the user insuring safety as the ladder will stay stable even on non flat ground.
